(19) United States
(12) Patent Application Publication
(10) Pub. No.: US 2016/0308867 A1
(43) Pub. Date: Oct. 20, 2016

(54) METHOD AND SYSTEM FOR SECURE REMOTE ACCESS AND CONTROL USING SHARED RESOURCES

(71) Applicant: BOMGAR CORPORATION, Ridgeland, MS (US)

(72) Inventors: Brandon Wilson HOLBROOK, Ridgeland, MS (US); John Burns SMITH, Charlotte, NC (US); David William DURHAM, Raymond, MS (US)

(21) Appl. No.: 15/133,636

(22) Filed: Apr. 20, 2016

Related U.S. Application Data
(60) Provisional application No. 62/150,067, filed on Apr. 20, 2015.

(51) Int. Cl. H04L 29/06; G06F 9/455

(52) U.S. Cl. CPC H04L 63/0884; H04L 63/102; G06F 9/45558; G06F 2009/45595

(57) ABSTRACT

An approach is provided for a secure remote access and control in a shared resource model. The approach involves initiating a logically separate instance of a virtual appliance using one or more shared computing resources of at least one shared resource provider. The approach also involves initiating an agent at an administrator system associated with the logically separate instance of the virtual appliance, wherein the agent services authentication requests directed to the virtual appliance by acting as a proxy or a push agent to the at least one shared resource provider.

### RELATED APPLICATIONS

This application claims the benefit of the earlier filing date under 35 U.S.C. §119(e) of U.S. Provisional Application Ser. No. 62/150,067 filed Apr. 20, 2015, entitled “Method and System for Secure Remote Access and Control using Shared Resources”; the entirety of which is incorporated by reference.

### BACKGROUND OF THE INVENTION

Software As a Service (SaaS) is a growing field wherein shared resources are used to offer services that are economical to consume. Even though it is economically advantageous there are certain security related challenges that SaaS offerings pose. For example, use of shared resources can potentially expose all users of the service to the same baseline security procedures and policies that are enforced by the provider. This potentially can result in, for instance, customer data loss due to exploitation of a single vulnerability, resource contention, limited options for configurability and data protection, and so on. In some cases, baseline security procedures and policies may not be sufficient for organizations that would require the latest available protections, and stricter policies may leave some customers unable to use the service. Hence, customers of SaaS providers often end up with making tradeoffs that may not be in the best interests of their organization's security posture.

As a result, a secure remote access and control is offered in a SaaS or shared resource model.

### BRIEF DESCRIPTION OF THE DRAWINGS

FIG. 1A is a diagram of a system and associated process for providing a secure remote support using shared resources, according to certain embodiments;

FIG. 1B is a flowchart of a system and associated process for providing a secure remote support using shared resources, according to certain embodiments;

FIG. 2 is an exemplary hardware architecture of a shared hardware 101, according to one embodiment;

FIG. 3 is a flowchart of a process for providing a secure remote support using shared resources, according to one example embodiment;

FIG. 4 is a flowchart of a process for selecting at least one shared resource, and configuring at least one agent, according to one example embodiment;

FIG. 5 is a flowchart of a process for downloading and configuring an agent, and migrating virtual appliance, according to one example embodiment;

FIG. 6 illustrates a computer system 600 upon which an embodiment according to the invention can be implemented; and

FIG. 7 illustrates a chip set 700 upon which an embodiment of the invention may be implemented.

### DESCRIPTION OF THE PREFERRED EMBODIMENT

A system and method for secure remote access and control using shared resources is described. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

When embodiments are described with respect to a wired network, it is contemplated that these embodiments have applicability to other networks including wireless systems. Similarly when embodiments are described with respect to computing devices they have applicability to physical, virtual, mobile, handheld, headless, and graphical devices and systems.

Service providers that manage their customers' (or organizations′) computer systems are constantly challenged to provide timely, secure, and cost-effective support. Remote support provides the means to remotely access and control customers' (or organizations′) computer systems thereby minimizing delay in response time. However, traditional remote support approaches possess a number of drawbacks, for example, an Application Service Provider (ASP) hosted approach (also known as SaaS) requires customers to route all centrally stored or logged data communication through a third party data center, thereby potentially exposing customers to security risks due to application vulnerabilities in other hosted applications.

Certain SaaS providers offer means to setup an individual instance per customer and offer management services. Usually, these are offered only to customers that offer significant revenue to the provider. Moreover, the service remains controlled and/or managed by the SaaS provider. Traditionally, SaaS providers use their own authentication and authorization schemes and organizations, even if the providers are using industry standard tools and mechanisms such as Lightweight Directory Access Protocol (LDAP), remote authentication dial-in user service (RADIUS), Kerberos, etc. Hence, customers are generally forced to adopt SaaS providers' authentication mechanisms. Furthermore, this also results in additional burden for organizations when managing disparate user accounts and all the related policy enforcements. Additionally, auditing, logging, and/or reporting the data stored at the SaaS provider can often be difficult to extract and use. Though certain SaaS providers offer data backup and direct database connectivity, storing and using the data on customer's own premise can be cumbersome as the customer themselves are responsible for creating the required applications, databases, and tools for extracting and using this data. Further, a direct database access may also require opening more ports on the firewall.

Based on the foregoing, a secure remote access and control when a service is offered in a SaaS or shared resource model can be offered. Remote access and control of information systems often require high levels of security (e.g., complete and secure audit trail), adaptation to individual organizational need, and a solution that works across firewalls. As a result, system 100 provides a secure remote access and control that is adaptable to an organization's security posture, works across firewalls, provides secure and complete audit trail, and provides isolation and protection from other users while not losing the economic benefits.

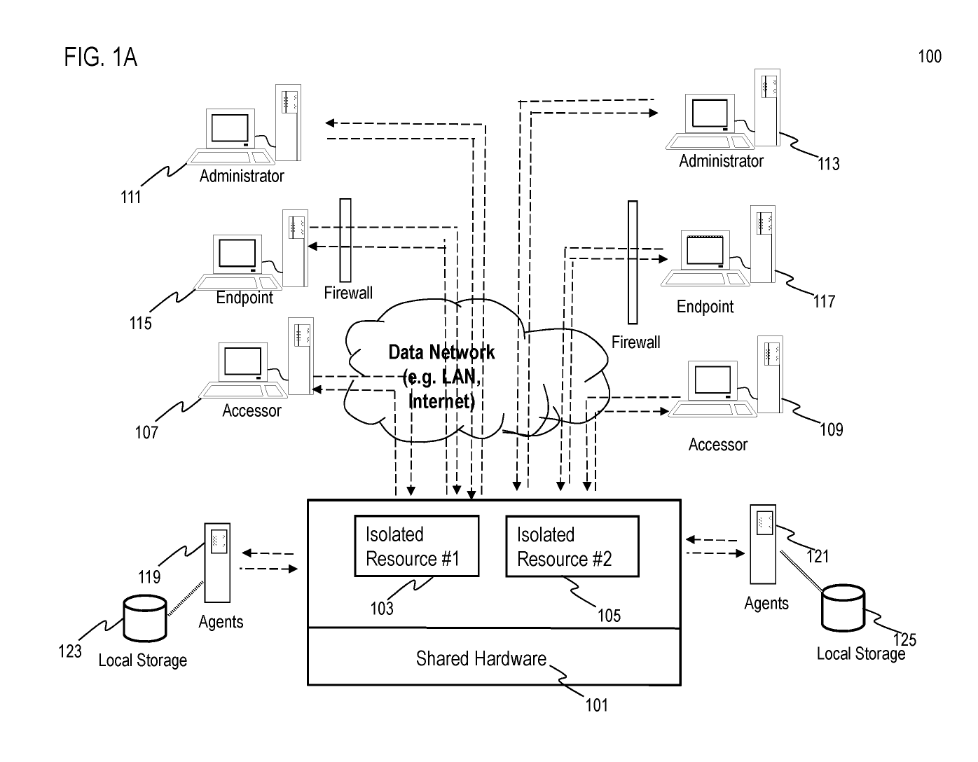

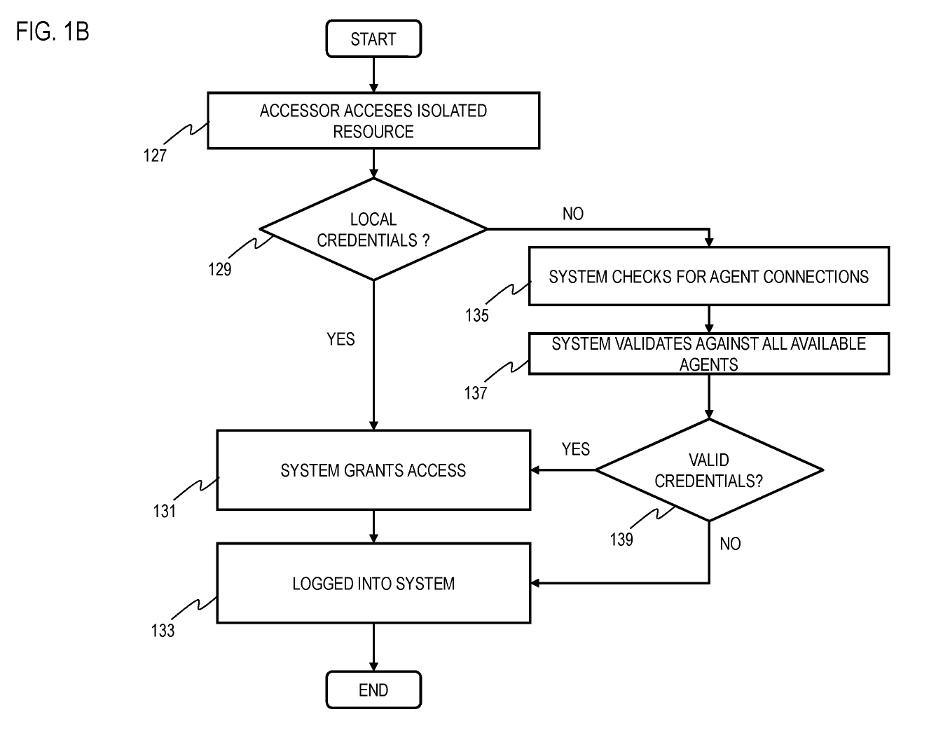

FIG. 1A is a diagram of a system and associated process for providing remote access and control using shared resources, according to certain embodiments. In one embodiment, shared hardware 101 is used to provide services to a plurality of customers via isolated resources 103 and 105, among others, to provide a layer of isolation among customer instances. For example, the isolated resources 103 and 105 may provide logical separation across shared hardware 101 but may not offer security settings that can be controlled by customer's use of applications. In one embodiment, agents 119 and 121 are provided for the purposes of allowing users to make cryptographic and access related configuration choices. For illustrative purposes, at least one user may choose to use only Transport Layer Security (TLS) v1.2 and disable all other transport encryption mechanisms, whereas at least one other user may choose to use TLS v1.1 only. Similarly, at least one user may choose his/her own custom domain name service (DNS) entry to access the service so as to mask the use of a shared service. In certain embodiments, the various systems described may include the users of each system, such as the user accessor of the accessor systems 107 and 109, administrative user of the administrator systems 111 and 113, user of endpoint systems 115 and 117, and agent user of the agents 119 and 121.

In the embodiment, isolated resources 103 and 105 may serve as a remote access, control, management, audit, and reporting system for one or more organizations. In some embodiments, isolated resources 103 and 105 may by virtual appliances. This provides one or more organizations with the capability to allow on-demand product use from anywhere in the world. As the service is deployed using a public IP address, an accessor 107 and 109 or administrative user of an administrator systems 111 and 113 can log in to his/her account via a web interface or use a mobile application to connect to and gain access to the service or the endpoints 115 and 117. In one embodiment, endpoints 115 and 117 can also be accessed and controlled by an accessor 107 and 109 via agents 119 and 121 that handle protocol conversions and bridge disparate networks, e.g., by acting as proxies or push agents. In another embodiment, the accessors 107 and 109 may gain access to the virtual appliance via the use of access consoles, and endpoints may be accessed and controlled via use of endpoint clients. The agents 119 and 121 can receive, handle, manage, and dispatch system or data messages to and from the access consoles and endpoint clients via a secure connection (e.g., 256-bit Advance Encryption Standard (AES) TLS). In another embodiment, to facilitate broadest reach and to easily work through firewalls and proxy servers, all the connections from the clients, agents, and managers are initiated outbound towards the virtual appliance.

In one embodiment, each virtual appliance consists, among other means, a web server, applications, databases, downloadable installers, tools for appliance management, communication mechanisms, and means for storing recordings, recording viewers, and self-checking mechanisms. In another embodiment, the web server and applications may be used by the an administrative user of the administrator systems 111 and 113 in setting up authentication, authorization, security, data retention, data download and use, and other customer specific configuration. In one scenario, the administrator 111 and 113 may organize the network. In a further embodiment, a complete recordings and/or snapshots of remote access and control, audit and log data is stored in the local storage 123 and 125, and the recorded data are made available for extraction. In one example embodiment, extraction tools and tools to set-up the required framework at the customer's premise may be accessible via web interface.

In one embodiment, a logically separate instance of the solution is created on shared hardware 101 by using a virtual appliance. This virtual appliance is made available for use on a public IP address. By way of example, an administrator 111 and 113 chooses a specific DNS to resolve to the public IP. The administrator 111 and 113 can also secure communications using, e.g., a Secure Sockets Layer (SSL) certificate valid for that DNS and by choosing one or more appropriate TLS protocol versions. The TLS module ensures all data transfer are encrypted, e.g., 256-bit AES encryption. In one embodiment, the administrator 111 and 113 can download and configure an agent 119 and 121 for authentication purposes. This Agent 119 and 121 (e.g., when installed on customer's premise and provided sufficient information) can make, for instance, an outbound connection to the virtual appliance and make itself available to service any authentication requests. In one embodiment, the agent 119 and 121 can service LDAP, RADIUS and other authentication requests.

In one embodiment, an administrator 111 and 113 may set up the agent 119 and 121 to download session data and recordings as they happen for safe keeping. In another embodiment, the administrator 111 and 113 may instruct accessor 107 and 109 to download their access consoles from the web interfaces. The administrator 111 and 113 can also direct end users to download clients to their endpoints 115 and 117 or download and push endpoint client installers to end machines using system management tools. In this embodiment, the administrator 111 and 113 maintains full control over their security posture, use of preferred authentication mechanism, and secured audit data. In one embodiment, all access to the system 100 either by agents 119 and 121 or clients is outbound towards the virtual appliance on a single port, no inbound firewall ports are open and traffic to and from that single port can be effectively monitored.

In one embodiment, shared hardware 101 resources can be managed and provided by different providers. Shared resource providers charge for resources differently and, in one embodiment, the system 100 arbitrages costs by picking the least expensive provider for storage, network, memory, and CPU resources. In one embodiment, the system 100 migrates load either of storage or computing resources to the most economical provider while maintaining uninterrupted service. It is noted that cost is discussed only as one possible example of a parameter that the system 100 can use for managing load across available storage, network, memory, and/or computing resources, and is not intended as a limitation. Accordingly, it is contemplated that the system 100 may use any parameter (e.g., service reliability, popularity, use preference, etc.) or combination of parameters to determine how to make use of shared resources.

FIG. 1B is a flowchart of a system and associated process for providing a secure remote support using shared resources, according to certain embodiments. In step 127, one or more accessors 107 and 109 may initiate a contact with a virtual appliance using one or more shared computing resources to access endpoints 115 and 117. Then, in step 129, the one or more administrator 111 and 113 may examine the local credentials of the one or more accessors 107 and 109. In step 131, the one or more accessors 107 and 109 may be granted access to a secure remote support system based, at least in part, on authentication of the local credentials. On the other hand, the administrator 111 and 113 upon determination that the one or more accessors 107 and 109 do not satisfy the local credentials requirements may check for one or more agents 119 and 121 (step 135). In one embodiment, these agents services authentication requests by acting as a proxy or a push agent to the at least one shared resource provider. In step 137, the administrator 111 and 113 may assess the access credentials provided by the one or more agents 119 and 121 on behalf of the one or more accessors 107 and 109 (step 139). The administrator 111 and 113 may determine the credentials to be valid whereupon the one or more accessors 107 and 109 may be granted access to a secure remote connection based, at least in part, on valid credentials (step 139).

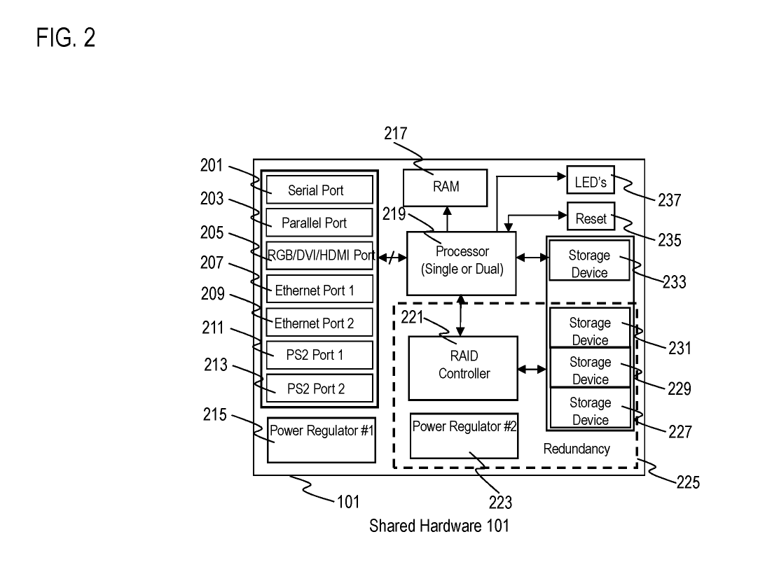

FIG. 2 is a diagram showing exemplary components of a shared hardware 101, according to various embodiments. As seen in FIG. 2, the shared hardware 101, in one embodiment, comprises various component interfaces, including serial and parallel ports 201 and 203, a display interface (e.g., an RGB (Red, Green and Blue) port 205), a local area network (LAN) ports (e.g., Ethernet ports) 207 and 209, and input device ports (e.g., PS2) 211 and 213. The shared hardware 101 also contains a power regulator 215, internal memory in the form of RAM (Random Access Memory) 217, one or more processors 219, each which may be a multi-core processor, LEDs (Light Emitting Diodes) 237, reset control 235 and a SATA (Serial Advanced Technology Attachment) storage drive 233.

In one embodiment, the shared hardware 101, can be a 1U rack-mountable server hardware. However, it is contemplated that configurations other than those illustrated in FIG. 2 can be constructed, depending on the particular applications. For example, different types of appliances can be designed for different uptime requirements. With uptime-critical customers, the shared hardware 101 provides for fail-over redundancies; e.g., use of multiple disk drives 227-231, for Fail-over and Hot-Swap capabilities via a RAID (Redundant Array of Independent Disks) controller 221. This configuration of the shared hardware 101 can also be equipped with a backup AC-DC (Alternating Current-Direct Current) regulator 223, which can be triggered when the main regulator 215 is detected as non-functional. Alternatively, for non-uptime-critical customers, the shared hardware 101 can be configured without the additional hardware and/or software required for providing redundancies.

The shared hardware 101 is configured to communicate with the accessor 107 and 109, administrator 111 and 113, and endpoint 115 and 117, and can be collocated within either of these systems. The shared hardware 101, in various embodiments, executes software applications that can receive, handle, manage, and dispatch system or data messages to and from the respective accessor 107 and 109, administrator 111 and 113, and endpoint 115 and 117 via secure links. In one embodiment, the security on these links is achieved using the 256-bit Advance Encryption Standard (AES) Secure Sockets Layer (SSL).

In one embodiment, the shared hardware 101 may be a virtual appliance. The software appliance in the shared hardware 101 may run in a virtual environment. For instance, an image of the operating system and base software application can be installed on a virtual machine. Virtualization provides an abstraction layer that separates the operating system from the hardware, as to permit resource sharing. In one scenario, virtualization is a methodology of dividing the resources of a computer (hardware and software) into multiple execution environments, by applying one or more concepts or technologies such as hardware and software partitioning, time-sharing, partial or complete machine simulation or emulation allowing multiple operating systems, or images, to run concurrently on the same hardware. In this matter, different virtual machines (using heterogeneous operating systems) can co-exist on the same hardware platform.

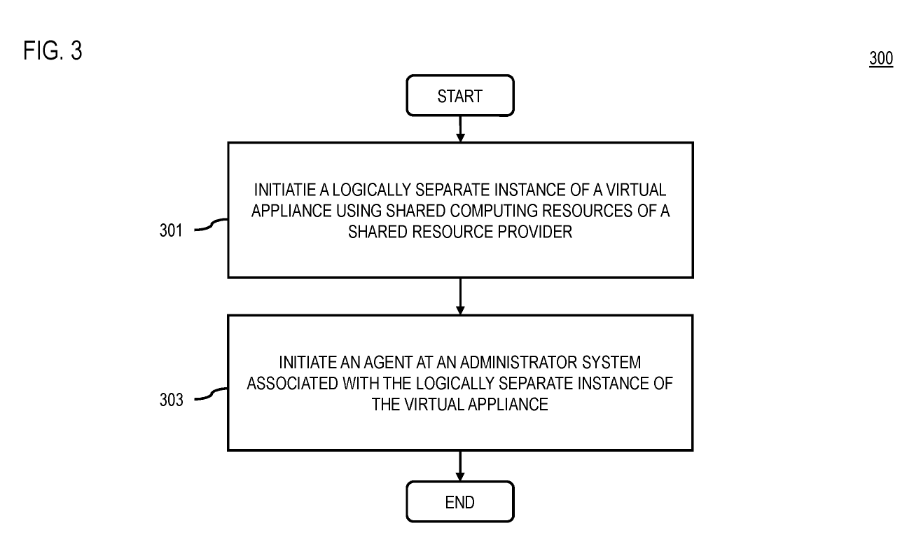

FIG. 3 is a flowchart of a process for providing a secure remote support using shared resources, according to one example embodiment.

In step 301, the administrator 111 and 113 may initiate a logically separate instance of a virtual appliance using one or more shared computing resources of at least one shared resource provider. In one scenario, a logically separate instance of a virtual appliance involves separating a virtual resource into multiple sets of isolated resources so that each set of isolated resources can be operated independently with its own operating system instance and applications. In another scenario, virtual machines may be classified and structured logically, for example, a separation of a virtual network (e.g., traffic between application groups) to ensure that users and services authorized for one application cannot inappropriately access other applications residing in a different trust zone. In one embodiment, the virtual appliance manages access rights and network traffic between a plurality of endpoints of a network and one or more accessor devices that seek access to at least one of the plurality of endpoints. In a further embodiment, the one or more connections between the plurality of endpoints, the one or more accessor device, one or more other systems with connectivity to the virtual appliance, or a combination thereof are initiated as outbound connections towards the virtual appliance.

In step 303, the administrator 111 and 113 may initiate an agent at an administrator system associated with the logically separate instance of the virtual appliance. The agent services authentication requests directed to the virtual appliance by acting as a proxy or a push agent to the at least one shared resource provider. In one example embodiment, the agent may act as a proxy or push agent to interact with a virtual appliance on behalf of an accessor, using the credentials provided by the accessor, to authenticate the accessor 107 and 109, and/or user accessor of the accessor 107 and 109. In one embodiment, the agent provides a protocol conversion function, a network bridging function, or a combination thereof to act as the proxy or the push agent.

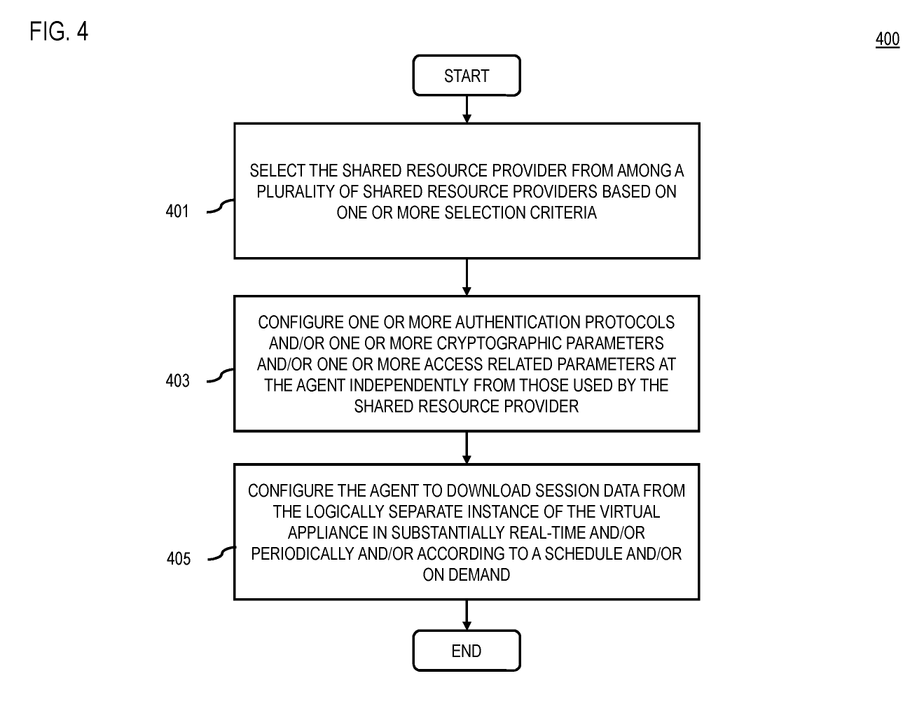

FIG. 4 is a flowchart of a process for selecting at least one shared resource, and configuring at least one agent, according to one example embodiment.

In step 401, the administrators 111 and 113 may select at least one shared resource provider from among a plurality of shared resource providers based on one or more selection criteria. The logically separate instance of the virtual appliance is initiated using at least one selected shared resource provider. The one or more selection criteria include a cost criterion, a service reliability criterion, a popularity criterion, a preference criterion, or a combination thereof.

In step 403, the administrators 111 and 113 may configure one or more authentication protocols, one or more cryptographic parameters, one or more access related parameters, or a combination thereof at or by the agent independently from those used by the at least one shared resource provider. In one example embodiment, the one or more authentication protocols includes appropriate TLS protocol versions, a DNS entry, an SSL certificate valid for a DNS entry, or a combination thereof.

In step 405, the administrators 111 and 113 may configure the agent to download session data from the logically separate instance of the virtual appliance in substantially real-time, periodically, according to a schedule, on demand, or a combination thereof. This limitation provides for the ability to not leave any data for a third party to access for any duration of time and provides the administrator of the appliance control over data retention and deletion policies.

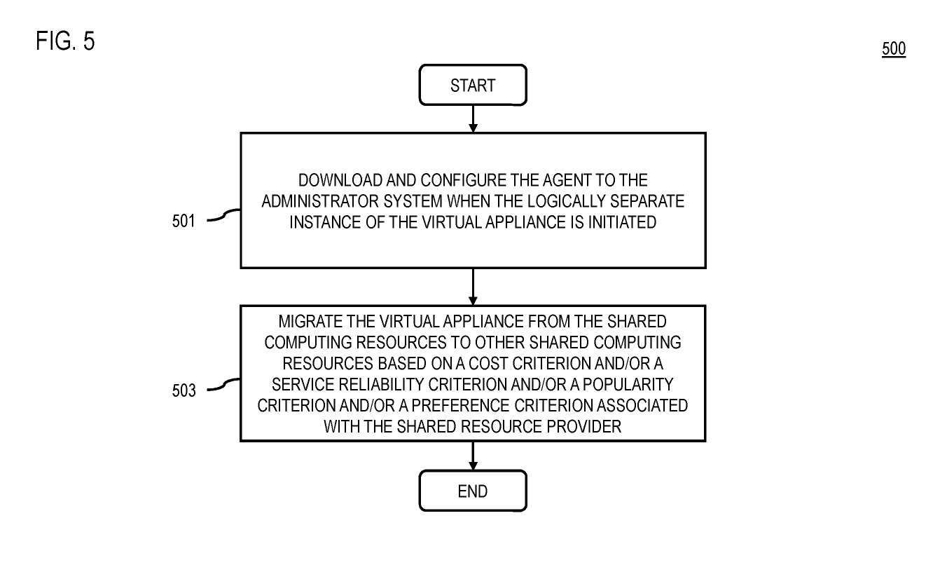

FIG. 5 is a flowchart of a process for downloading and configuring an agent, and migrating virtual appliance, according to one example embodiment.

In step 501, the administrators 111 and 113 may download and configure the agent to their system when the logically separate instance of the virtual appliance is initiated.

In step 503, the administrators 111 and 113 may migrate the virtual appliance from the one or more shared computing resources to one or more other shared computing resources based on a cost criterion, a service reliability criterion, a popularity criterion, a preference criterion, or a combination thereof associated with the at least one shared resource provider.

The processes described herein may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

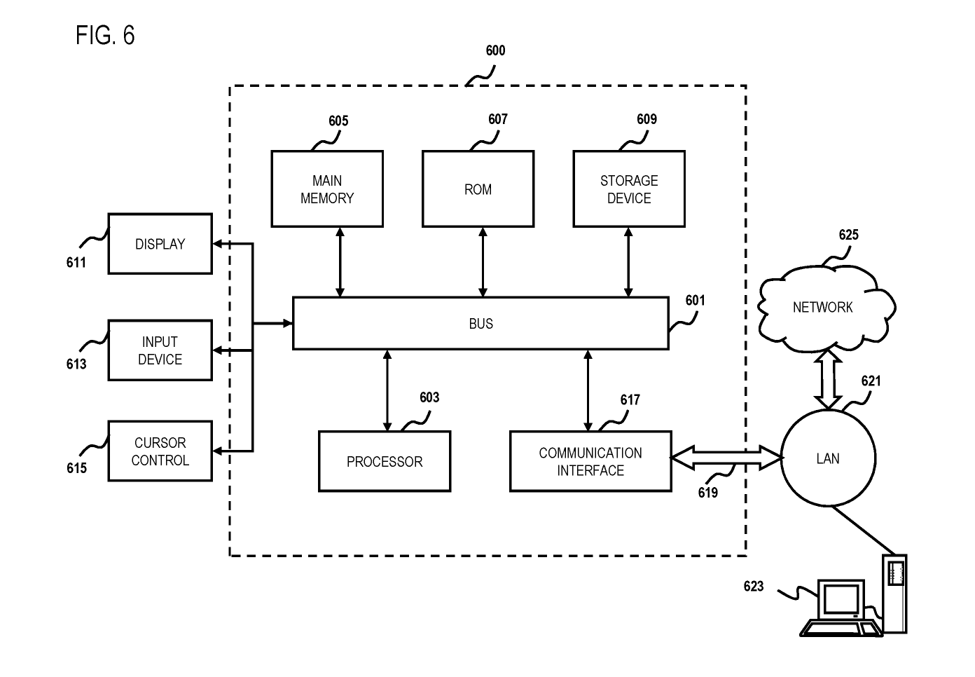

FIG. 6 illustrates a computer system 600 upon which an embodiment according to the invention can be implemented. For example, the processes described herein can be implemented using the computer system 600. The computer system 600 includes a bus 601 or other communication mechanism for communicating information and a processor 603 coupled to the bus 601 for processing information. The computer system 600 also includes main memory 605, such as a random access memory (RAM) or other dynamic storage device, coupled to the bus 601 for storing information and instructions to be executed by the processor 603. Main memory 605 can also be used for storing temporary variables or other intermediate information during execution of instructions by the processor 603. The computer system 600 may further include a read only memory (ROM) 607 or other static storage device coupled to the bus 601 for storing static information and instructions for the processor 603. A storage device 609, such as a magnetic disk or optical disk, is coupled to the bus 601 for persistently storing information and instructions.

The computer system 600 may be coupled via the bus 601 to a display 611, such as a cathode ray tube (CRT), liquid crystal display, active matrix display, or plasma display, for displaying information to a computer user. An input device 613, such as a keyboard including alphanumeric and other keys, is coupled to the bus 601 for communicating information and command selections to the processor 603. Another type of user input device is a cursor control 615, such as a mouse, a trackball, or cursor direction keys, for communicating direction information and command selections to the processor 603 and for controlling cursor movement on the display 611.

According to an embodiment of the invention, the processes described herein are performed by the computer system 600, in response to the processor 603 executing an arrangement of instructions contained in main memory 605. Such instructions can be read into main memory 605 from another computer-readable medium, such as the storage device 609. Execution of the arrangement of instructions contained in main memory 605 causes the processor 603 to perform the process steps described herein. One or more processors in a multi-processing arrangement may also be employed to execute the instructions contained in main memory 605. In alternative embodiments, hard-wired circuitry may be used in place of or in combination with software instructions to implement the embodiment of the invention. Thus, embodiments of the invention are not limited to any specific combination of hardware circuitry and software. The computer system 600 may further include a Read Only Memory (ROM) 607 or other static storage device coupled to the bus 601 for storing static information and instructions for the processor 603.

The computer system 600 also includes a communication interface 617 coupled to bus 601. The communication interface 617 provides a two-way data communication coupling to a network link 619 connected to a local network 621. For example, the communication interface 617 may be a digital subscriber line (DSL) card or modem, an integrated services digital network (ISDN) card, a cable modem, a telephone modem, or any other communication interface to provide a data communication connection to a corresponding type of communication line. As another example, communication interface 617 may be a local area network (LAN) card (e.g. for Ethernet™ or an Asynchronous Transfer Model (ATM) network) to provide a data communication connection to a compatible LAN. Wireless links can also be implemented. In any such implementation, communication interface 617 sends and receives electrical, electromagnetic, or optical signals that carry digital data streams representing various types of information. Further, the communication interface 617 can include peripheral interface devices, such as a Universal Serial Bus (USB) interface, a PCMCIA (Personal Computer Memory Card International Association) interface, etc. Although a single communication interface 617 is depicted in FIG. 6, multiple communication interfaces can also be employed.

The network link 619 typically provides data communication through one or more networks to other data devices. For example, the network link 619 may provide a connection through local network 621 to a host computer 623, which has connectivity to a network 625 (e.g. a wide area network (WAN) or the global packet data communication network now commonly referred to as the “Internet”) or to data equipment operated by a service provider. The local network 621 and the network 625 both use electrical, electromagnetic, or optical signals to convey information and instructions. The signals through the various networks and the signals on the network link 619 and through the communication interface 617, which communicate digital data with the computer system 600, are exemplary forms of carrier waves bearing the information and instructions.

The computer system 600 can send messages and receive data, including program code, through the network(s), the network link 619, and the communication interface 617. In the Internet example, a server (not shown) might transmit requested code belonging to an application program for implementing an embodiment of the invention through the network 625, the local network 621 and the communication interface 617. The processor 603 may execute the transmitted code while being received and/or store the code in the storage device 609, or other non-volatile storage for later execution. In this manner, the computer system 600 may obtain application code in the form of a carrier wave.

The term “computer-readable medium” as used herein refers to any medium that participates in providing instructions to the processor 603 for execution. Such a medium may take many forms, including but not limited to non-volatile media, volatile media, and transmission media. Non-volatile media include, for example, optical or magnetic disks, such as the storage device 609. Volatile media include dynamic memory, such as main memory 605. Transmission media include coaxial cables, copper wire and fiber optics, including the wires that comprise the bus 601. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

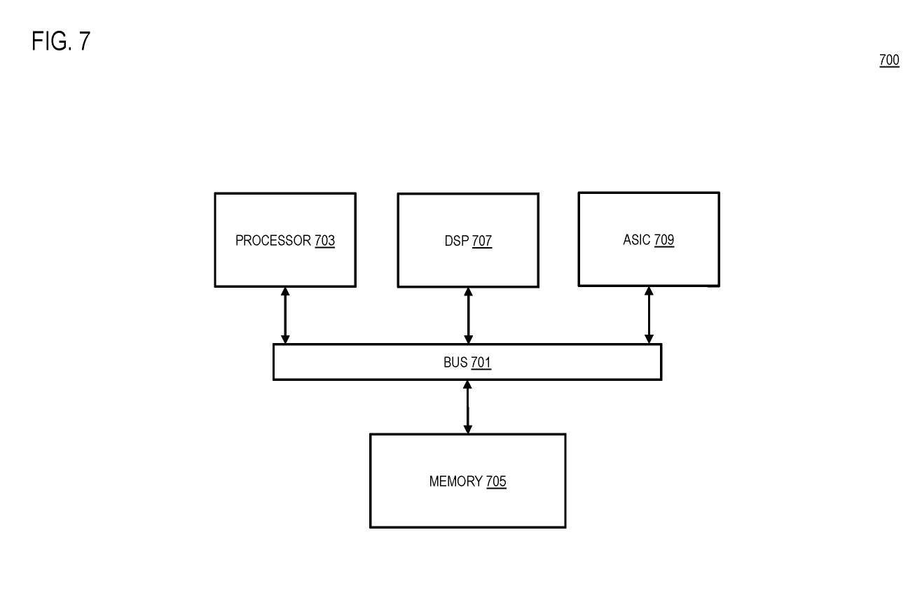

FIG. 7 illustrates a chip set 700 upon which an embodiment of the invention may be implemented. Chip set 700 is programmed to present a slideshow as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 700, or a portion thereof, constitutes a means for performing one or more steps of FIGS. 3-5.

In one embodiment, the chip set 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to controlling a set-top box based on device events. The memory 705 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method comprising:
initiating a logically separate instance of a virtual appliance using one or more shared computing resources of at least one shared resource provider; and
initiating an agent at an administrator system associated with the logically separate instance of the virtual appliance,
wherein the agent services authentication requests directed to the virtual appliance by acting as a proxy or a push agent to the at least one shared resource provider.

2. A method of claim 1, further comprising:
selecting the at least one shared resource provider from among a plurality of shared resource providers based on one or more selection criteria,
wherein the logically separate instance of the virtual appliance is initiated using the selected at least one shared resource provider.

3. A method of claim 2, wherein the one or more selection criteria include a cost criterion, a service reliability criterion, a popularity criterion, a preference criterion, or a combination thereof.

4. A method of claim 1, further comprising:
configuring one or more authentication protocols, one or more cryptographic parameters, one or more access related parameters, or a combination thereof at the agent independently from those used by the at least one shared resource provider.

5. A method of claim 1, further comprising:
configuring the agent to download session data from the logically separate instance of the virtual appliance in substantially real-time, periodically, according to a schedule, on demand, or a combination thereof.

6. A method of claim 1, wherein the virtual appliance manages access rights and network traffic between a plurality of endpoints of a network and one or more accessor devices that seek access to at least one of the plurality of endpoints.

7. A method of claim 6, wherein one or more connections between the plurality of endpoints, the one or more accessor device, one or more other systems with connectivity to the virtual appliance, or a combination thereof are initiated as outbound connections towards the virtual appliance.

8. A method of claim 1, further comprising:
downloading and configuring the agent to the administrator system when the logically separate instance of the virtual appliance is initiated.

9. A method of claim 1, further comprising:
migrating the virtual appliance from the one or more shared computing resources to one or more other shared computing resources based on a cost criterion, a service reliability criterion, a popularity criterion, a preference criterion, or a combination thereof associated with the at least one shared resource provider.

10. A method of claim 1, wherein the agent provides a protocol conversion function, a network bridging function, or a combination thereof to act as the proxy or the push agent.

11. An apparatus comprising:
at least one processor; and
at least one memory including computer program code for one or more programs,
the at least one memory and the computer program code configured to, with the at least one processor, cause the apparatus to perform at least the following;
initiate a logically separate instance of a virtual appliance using one or more shared computing resources of the apparatus; and
initiate an agent at an administrator system associated with the logically separate instance of the virtual appliance,
wherein the agent services authentication requests directed to the virtual appliance by acting as a proxy or a push agent to the apparatus.

12. An apparatus according to claim 11, further comprising:
select the apparatus from among a plurality of shared resource providers based on one or more selection criteria,
wherein the logically separate instance of the virtual appliance is initiated using the selected apparatus.

13. An apparatus according to claim 12, wherein the one or more selection criteria include a cost criterion, a service reliability criterion, a popularity criterion, a preference criterion, or a combination thereof.

14. An apparatus according to claim 11, further comprising:
configure one or more authentication protocols, one or more cryptographic parameters, one or more access related parameters, or a combination thereof at the agent independently from those used by the apparatus.

15. An apparatus according to claim 11, further comprising:
configure the agent to download session data from the logically separate instance of the virtual appliance in substantially real-time, periodically, according to a schedule, on demand, or a combination thereof.

16. An apparatus according to claim 11, wherein the virtual appliance manages access rights and network traffic between a plurality of endpoints of a network and one or more accessor devices that seek access to at least one of the plurality of endpoints.

17. An apparatus according to claim 11, wherein one or more connections between the plurality of endpoints, the one or more accessor device, one or more other systems with connectivity to the virtual appliance, or a combination thereof are initiated as outbound connections towards the virtual appliance.

18. An apparatus according to claim 11, further comprising:
download and configure the agent to the administrator system when the logically separate instance of the virtual appliance is initiated.

19. An apparatus according to claim 11, further comprising:
migrate the virtual appliance from the one or more shared computing resources to one or more other shared computing resources based on a cost criterion, a service reliability criterion, a popularity criterion, a preference criterion, or a combination thereof associated with the apparatus.

20. An apparatus according to claim 11, wherein the agent provides a protocol conversion function, a network bridging function, or a combination thereof to act as the proxy or the push agent.
